(19) United States
(12) Patent Application Publication
(10) Pub. No.: US 2010/0287113 A1
(43) Pub. Date: Nov. 11, 2010

(54) System and process for managing beta-controlled porfolios

(76) Inventors: Andrew W. Lo, Weston, MA (US); Jeremiah Harrison Chafkin, Chestnut Hill, MA (US)

Correspondence Address: Troutman Sanders LLP, The Chrysler Building, 405 Lexington Avenue, New York, NY, 10174, US

(21) Appl. No.: 12/387,898

(22) Filed: May 8, 2009

(51) Int. Cl. G06Q 40/00; G06Q 50/00

(52) U.S. Cl. 705/36 R; 705/37

(57) ABSTRACT

A computer system is selectively programmed to support one or more investment portfolios that have applied to them a counter balancing investment so as to achieve and maintain a target sensitivity to one or more broad market parameters through dynamic multi-beta hedging. The computer system is programmed to process input data relating to a portfolio's expected volatility based on its broad market exposures and the volatility of these broad markets, a target portfolio volatility, and historical volatility performance over a selected interval, and based thereon, modify the portfolio so as to achieve a future volatility corresponding to the selected target.

### INTRODUCTION

The present invention involves novel financial management systems and technologies. More specifically, the present invention is directed to a computer controlled system for managing parameters and accounts that track and regulate portfolio or index volatility.

### BACKGROUND

Investments and other assets are priced by markets in a number of ways. Traditionally, investments such as stocks and bonds are priced on exchanges and other trading facilities. As demand for various financial products grows, prices often increase, albeit in local currency terms—dollars for the U.S.

Because of the importance various assets play in financing growth, savings and investment, there are many calculations and associated parameters used to determine and assess performance and value of these assets. For example, price growth is an important asset parameter for equity securities such as common stocks; and “yield” is an important parameter for fixed income securities, such as bonds. There are many different forms of performance measurement that have been used over the years to help characterize asset value and performance. Use of these parameters allows investors to more accurately track and modify their holdings and to thus control the direction of their investments in terms of risk and expected return.

Due to recent market trends, one parameter has grown in notoriety. Specifically, the concept of “volatility” has become increasingly common in the lexicon of the markets, where volatility measures the size and timing of price changes of select securities. Volatility is considered an indication of market risk associated with holding the underlying security, where volatile investments, i.e., investments with prices that fluctuate broadly, are considered riskier than less volatile investments (those with more stable price movements).

The measure of risk for a given security or portfolio of securities is therefore an important parameter and is typically considered in conjunction with “expected return” to assess the value of a given investment or strategy. The term “alpha” is used to measure the expected return above the broad market risk premia represented in a portfolio's returns.

There are several methods for calculating the volatility of a particular market or asset class for past and projected future periods. Perhaps one of the best known measures is called the “volatility index” or VIX. This value was introduced in 1993 by the Chicago Board Options Exchange (CBOE). In 2003, the VIX was modified and updated and is now based on the S&P 500 index. Specifically, the VIX estimates expected volatility by assessing puts and calls over a wide range of strike prices. The VIX is targeted at measuring future volatility and it accomplishes this by taking a composite assessment of option pricing for components of the S&P 500 Index:

$${σ}^{2} = \frac{2}{T} {\sum }_{i} \frac{Δ {K}_{i}}{{K}_{i}^{2}} {e}^{RT} Q ( {K}_{i} ) - {\frac{1}{T} [ \frac{F}{{K}_{0}} - 1 ]}^{2} \qquad ( 1 )$$

See generally, The CBOE Volatility Index®-VIX® copyright © 2009 Chicago Board Options Exchange, Incorporated, incorporated herein by reference (the individual variables for equation (1) are discussed therein). U.S. Patent Application Pub. No. 2004/0024695 A1 (2004) further presents a constant volatility index (the entire teachings thereof are hereby incorporated by reference herein). More recently, the VIX has been translated into a tradable security via limited future contracts permitting pure volatility exposure for, e.g., hedging purposes. The CBOE has expanded the concept to encompass other indices, such as the NASDAQ 100 (“VXU”), DJIA (“VXD”), etc. In 2008, the concept was extended into commodities (e.g., “oil”) and currencies.

For individual stocks, a measure of a stock's relative volatility is known as its “beta” value. For example, a stock with a beta of 1.0 will move in tandem with a given index. Beta values can be long (positive) or short (negative). The beta is used to reflect the sensitivity of an investment to price movements for a broad market index. A more detailed discussion of beta investing is illustrated in U.S. Pat. No. 5,126,936 (Champion, et al.),the entire contents of which are hereby incorporated herein by reference.

### OBJECTS AND TECHNOLOGICAL ENHANCEMENTS

The present invention involves computer systems and methods for use in support of risk-modified portfolio management or risk-modified index construction. One aspect of this invention involves the use of a scaling factor to adjust the beta of a portfolio or index in order to control its volatility or correlation.

Another aspect of the present invention is the use of a computer system and platform to track and implement an investment portfolio that permits selective control of portfolio volatility in accord with program control parameters. This approach advantageously ascertains betas for select broad markets—equity, currency, etc.—and enables volatility management either within each class or proportionately across all classes in order to remain neutral with regard to portfolio asset allocation.

A further aspect of the present invention is the selection and implementation of a volatility attenuation portfolio (or volatility attenuation program within an existing portfolio) tuned to rebalance investment price movements towards a target volatility level. Operation of the present invention implements short interval period adjustments, with intervals selected to permit dynamic beta hedging of the portfolio.

The above and other features of the present invention are fully described in the following detailed discussion of the specific illustrated embodiments provided in conjunction with the accompanying drawings.

### BRIEF DESCRIPTION OF THE FIGURES

For a more complete understanding of the specific embodiments, FIGS. 1-12 are provided as illustrations relating to the practice of the present invention, wherein:

FIG. 1A is a block diagram of an illustrative computer and network system for implementing the present invention;

FIG. 1B is a second illustrative block diagram depicting a computer and network system for implementing the present invention;

FIG. 2 is a flow chart depicting several calculations performed by the computer system in operation;

FIG. 3 is a system functional block diagram for the present invention;

FIG. 4 is a functional block diagram of the computer system for implementing the invention;

FIGS. 5a-5h depict seven (7) factors for beta hedging;

FIG. 6 depicts a sample portfolio and its component investments;

FIG. 7 provides time charts for portfolio performance;

FIG. 8 provides a time chart factor exposure for a fund of funds portfolio;

FIG. 9 provides return/loss information over a five-year period;

FIG. 10 provides a delineation of factor exposure and residual;

FIG. 11 provides a five year review of variance attributes; and

FIG. 12 provides statistical confirmation over the five year interval.

### DESCRIPTION OF THE INVENTION AND ILLUSTRATIVE EMBODIMENTS THEREOF

The present invention is best demonstrated by use of an illustrative example. In particular, the present invention, in one arrangement, is implemented by a selectively programmed computer platform that performs operations relating to portfolio management on an event and time based protocol. The computer system is configured to meet the level of processing necessary for the selected application. In one arrangement, operation is network based with investors, financial managers and system administrators communicating with a central server and associated database via distributed workstations interconnected through traditional internet protocols. Secondary feeds to the system processors are used to collect current or near-current market data. Account data is processed with changes stored. This occurs in batch mode (end of day pricing) or on a continuous basis depending on the nature of the securities and the programming of the system.

Smaller configurations are used to support a smaller operation and will be preferred where the investment fund is designed to address a limited group of investors or a single institutional investor. Operation on this scale will require a reduced hardware footprint and would be networked for internal access via industry recognized intranet protocols. In both platforms, security issues necessitate encryption and password access to account data. For such security and privacy requirements, software will provide the necessary firewalls, encryption and selective access in accordance with industry recognized standards.

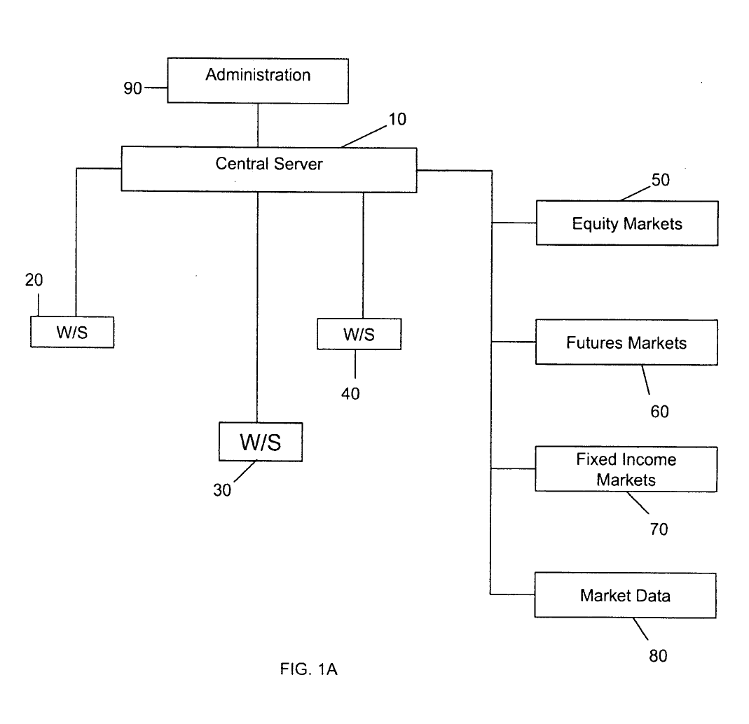

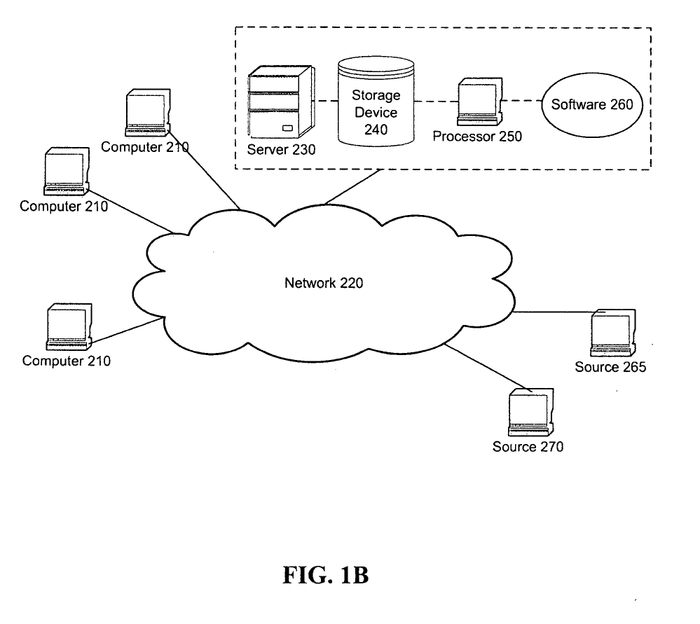

The present invention may be implemented on a distributed access computer system such as depicted in FIG. 1A. Turning now to FIG. 1A, a general block diagram of the inventive system is depicted. The computer platform includes a central server 10, governed by administrator module 90 under the control of a locally stored program and associated system instructions therein. The server 10 includes non-volatile memory (optical and/or magnetic based) and communicates through connections to secondary computers in accordance with TCP/IP. As described, three separate workstations are linked to the central server 10, although this number is for illustrative purposes only. It will be understood that many additional workstations, providing individual links to the server, may be employed, limited by the network bandwidth of the communication links.

Continuing in FIG. 1A, workstation 20 is separately programmed to permit data access and input to the server. Conventionally, this is accomplished by an Internet browser, although a dedicated interface may be desirable, depending on the application. While it is preferred that each workstation 20, 30 and 40 has a common system architecture and programming, this is not required. In fact, programming of the individual workstations may be somewhat customized depending on the needs for each user and the markets addressed (e.g., “retail” or “institutional”).

Server 10 is further connected to and in communication with computers tracking returns, prices and trading on various security markets, including various exchange/transaction sources. This is depicted by blocks 50, 60 and 70, each supporting transactions on equities, options and future contracts and fixed income securities, respectively. While not shown in this figure, communication links to markets for currency and commodity trading (and others), may be included without departing from the ambit of the present invention.

Embodiments of the present invention may comprise differing computer components and computer-implemented steps that will be apparent to those skilled in the art. An exemplary arrangement is further depicted in FIG. 1B. As shown, computers 210 communicate via network with a central server 230. A plurality of sources of data 265, 270 are provided, relating to, for example, securities spot pricing, trading volume, price movements and other trading data as retrieved from one or more established exchanges, or other trading platforms such as ECNs and the like. This source of data is linked to the system computer and communicates via network 220 with a central server 230, to calculate and transmit, for example, volatility data. The server 230 may be coupled to one or more storage devices 240, one or more processors 250, and is governed by software 260.

Other components/processors and combinations of components/processors may also be used to support processing of data or other calculations described herein as will be evident to those skilled in the art. Server 230 may facilitate communication of data from a storage device 240 to and from processor 250, and communications to computers 210. Processor 250 may optionally include local or networked storage (not shown) which may be used to store temporary information. Software 260 can be installed locally at a computer 210 and/or processor 250 and/or can be centrally supported for facilitating calculations and applications.

For simplicity of exposition, not every step or element of the present invention is described herein as part of a computer system and/or software, or as performed by a processor, but those skilled in the art will recognize that each step or element may have (and typically will have) a corresponding computer system or software component or processor. Such computer system and/or software components/processors are therefore enabled by describing their corresponding steps or elements (that is, their functionality), and are within the scope of the present invention.

Moreover, where a computer system is described or claimed as having a processor for performing a particular function, it will be understood by those skilled in the art that such usage should not be interpreted to exclude systems where a single processor, for example, performs some or all of the tasks delegated to the various processors. That is, any combination of, or all of, the processors specified in the description and/or claims could be the same processor. All such combinations are within the scope of the invention.

Alternatively, the processing and decision steps described herein can be performed by functionally equivalent circuits such as a digital signal processor circuit or an application specific integrated circuit. The details described herein do not specify the syntax of any particular programming language, but rather provide sufficient functional information to enable one of ordinary skill in the art to perform the functions/processes in accordance with the present invention. It should be noted that many routine program elements, such as initialization of loops and variables and the use of temporary variables, are not shown, but will be understood by those skilled in the art to be part of software embodiments where applicable.

It will be appreciated by those of ordinary skill in the art that unless otherwise indicated herein, the particular sequences of steps and configurations of system and software components described are illustrative only and can be varied without departing from the scope of the invention. The present invention has been described by way of example only, and the invention is not limited by the specific embodiments described herein. As will be recognized by those skilled in the art, improvements and modifications may be made to the illustrative embodiments described herein without departing from the scope or spirit of the invention.

Operation of the system is controlled by programming logic. To better express this logic, the following shorthand nomenclature is used.

TABLE 1

| | |
|---|---|
| VCP | Volatility-Controlled Portfolio or Index |
| RP | Reference Portfolio |
| VT | Volatility Target |
| VE | Volatility Estimate |
| VSF | Volatility Scaling Factor |
| VMI | Volatility Modifying Investment |

In principle, a portfolio of selected securities is created and set as the reference portfolio or RP. This portfolio can collect a vast array of different securities in a custom basket or can be set in accordance with an established index. The latter is exemplified by the S&P 500 and DJIA, among others. The RP forms the underlying investment that the system modulates with respect to price volatility. This modulation is accomplished by first setting a portfolio volatility target (VT), then calculating a scaling factor that, when applied to the broad market exposures of the RP, modulates volatility to meet the target. The foregoing calculations form the basis of the VCP, which reflects the combination of the RP with a selection of volatility modifying investments (VMI) to create the VCP.

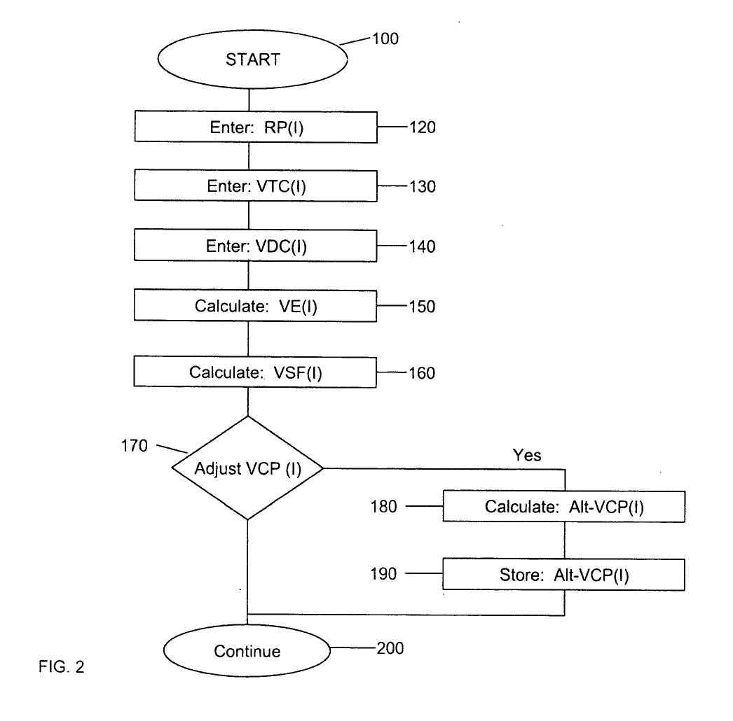

A variation of the foregoing is diagramed in FIG. 2 in conventional flow chart format. Logic conceptually begins at Start block 100, and the system receives a reference portfolio, RP(I) at block 120. The embedded letter “I” is an indexing variable, reflecting operation in a sequence of plural RPs, where “I” ranges from 1 to Imax, where Imax is the total number of separate RPs under system management. For illustration, assume that RP is a collection of ten stocks. At block 130, a volatility target is selected for that RP and entered. This target may be expressed in several different ways; for purposes of illustration, assume the VT is 10% (0.10) on an annualized basis.

At block 140, volatility data, VD(I) is entered. The volatility data can be assessed in several different ways. One approach is to track and collect historical price or return data for the RP over a select interval and then to employ the standard deviation of returns as an estimate of current volatility. Another approach is to create a proxy portfolio by identifying a combination of broad markets that best mimics the performance characteristics of the RP. The historical price or return data for the proxy portfolio are collected over an interval and the standard deviation of proxy portfolio returns are employed as an estimate of current volatility. Alternatively, the volatility data can be based on an established option derived value, such as the VIX discussed above. While all these approaches have their own advantages and disadvantages, none is distinctly better than the others for estimating current price volatility. The selected approach results in the VE(I) calculation, block 150 and, in turn, the volatility scaling factor VSF is calculated as follows:

VSF(I)=VT(I)VE(I) (2)

Equation (2) gives one of several different approaches for this calculation, which is depicted generically at block 160.

At Test 170, the VCP(I) is adjusted when the scaling factor deviates from 1.0 by a meaningful amount. This deviation reflects an expectation that the target and estimate are different and triggers a rebalancing effort to stabilize the VCP's volatility. Again, there are different approaches to this, and as depicted in block 180, a counterbalance investment position is created. In general, this is referred to as the VMI or volatility modifying investment. In this example, a second investment is created called Alt_VCP(I). The combination of the RP(I) and Alt_VCP(I) is designed to meet the target for volatility for this portfolio (I).

For example, if the VE=30 and the VT is 10, the Alt_VCP(I) must correspond to an investment that, when combined with RP(I) results in a VCP(I) that projects to meet the target volatility of 10 (annualized percentage). To accomplish this, the Alt_VCP(I) investment is established by taking investment positions in the futures market relative to the RP(I) on the selected interval date to achieve the counterbalance position in the selected assets.

Operation is dynamic in that for each selected interval, the counterbalance position is adjusted to meet the current market conditions. This adjustment is tempered, however, so that trading costs do not become prohibitive. Accordingly, adjustments are made only if the new conditions exceed a selected threshold.

In the above example, the VMI is created by identifying the weighted combination of broad market exposures that explain most of a portfolio's price volatility and then taking positions in each of the corresponding futures contracts to manage the portfolio's volatility up or down towards the target by proportionately adding to or offsetting these broad market exposures, thus modifying volatility without changing the relative relationship of each market exposure to the others. In the above example, the VMI would consist of futures contracts providing offsetting exposures equal to two-thirds of each broad market exposures in the RP. There are alternative methods for reaching the volatility target beyond buying or selling futures and/or forward contracts. For example, money can be borrowed to buy more of each investment in order to increase volatility, or investments can be proportionately sold to reduce market exposures and to increase cash, thereby dampening volatility. In this approach, volatility control is accomplished by adjusting the beta(s) for the portfolio without altering the asset allocation of the portfolio (excluding cash).

Other parameters may be adjusted and will depend on the portfolio and application. Specifically, end of day volatility targeting is expected to become the favored interval in view of historical end of day pricing. Shorter and longer intervals may be appropriate depending on the application and can include real-time, hourly, weekly, monthly, quarterly or other time intervals. The foregoing arrangement is capable of supporting a wide range of business operations, including institutional and retail based account management. To address multiple accounts, the system will iteratively process account data to determine if the account requires adjustment of its VMI, based on target volatility and current deviation from target volatility. To the extent that volatility adjustment is required, it is either accomplished individually in the marketplace, or on an aggregate basis for multiple accounts. For the latter, the system tracks the individual contribution to the aggregate modulating investment so this value can be applied during the next cycle.

In addition to the above volatility scaling factor, the present system program provides volatility caps and ranges, where the VMI is established and adjusted only when the expected volatility extends beyond the programmed cap or range.

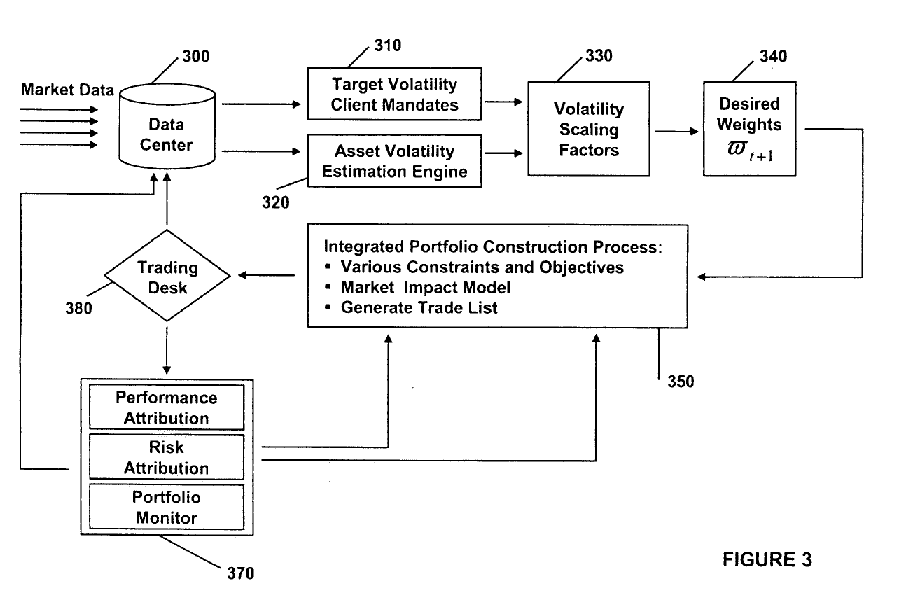

Turning now to FIG. 3, a further illustrative computer system is functionally depicted, here for use in support of an institutional investor, such as a hedge fund, mutual fund, or similar entity. Block 300 data center forms the core storage of investment data and security related details. Specifically, a portfolio is created and stored in memory reflecting actual investment in underlying securities.

System processors are depicted at blocks 310-350, where a string of calculations are processed by the computer under controlling logic. Again, at 310, a volatility target is set and at 320 the asset volatility estimate is created. For this illustrative example, the volatility estimate for the portfolio is calculated by first creating a database of historical market data for a proxy portfolio of broad market exposures. The proxy portfolio may include, for example, the S&P 500 Index taken together with the Lehman Aggregate Bond Index. For this example, the S&P 500 Index may have a volatility of 40% while the Lehman Aggregate Bond Index exhibits a 6% volatility. When combined in a ratio of 70:30 for the S&P 500 to the Lehman Aggregate, the resulting expected volatility (assuming zero correlation between the two indices) is 30%. The proxy portfolio volatility estimate is stored, and system operation continues. This results first in a volatility scaling factor, block 330 used to generate weights at block 340 for the futures, forwards, or securities making up the VMI.

In the next series of operations, block 350-380, the system loops through the determination of market positions and tracks, and then reconciles these new market conditions with the target portfolio through trades presented at the trading desk, block 380. This process occurs at computer implemented periodic intervals. Changes are applied and used to maintain the target volatility.

A separate approach involves volatility control by split-dynamic beta hedging. This technique involves disaggregating the volatility of a selected investment into components. For example, a real estate fund may include beta values for fixed income, U.S. dollar, and U.S. equities. The computer is programmed to determine a supplemental or counterbalancing investment position to each of these three components—a fixed-income hedge, coupled to an equity hedge, and, finally, coupled to a currency hedge. The three separate hedges are then recombined with other fixed-income, equity, and currency hedges to form a single composite hedge for each portfolio, which is applied to the real estate fund to modify its expected future volatility toward the selected target as entered and stored in the computer.

To dynamically hedge a portfolio, there are several processes that are implicated. To begin, as with the hedging techniques discussed, inter alia, above, expected volatility is determined. For the selected portfolio, the next step is to estimate the betas (i.e., the degree to which an investment's returns reflect the returns of one or more broad markets). Betas are estimated for each of the following broad markets:

TABLE II

| Category | Broad Markets/Asset Classes |
|---|---|
| Bonds: | U.S. 10 year Treasury, 10 year Japanese Government |
| | Bonds, German Bunds, U.K. Gilts, etc. |
| Equities: | S&P 500; Nikkei; TSE; DAX; CAC; FTSE; |
| | Russell 1000; Russell 3000; TOPIX, etc. |
| Short Term | |
| Interest Rates: | 90 day U.S.$ LIBOR |
| Currencies: | Yen, U.S. dollar, Krona, sterling, etc. |
| Commodities: | Gold, nickel, copper, crude oil, cotton, soy beans, etc. |

In general, once identified, the betas for the portfolio with respect to each broad market are adjusted by the scaling factor for the VCP to achieve the target beta for each broad market that would be associated with a portfolio of the target volatility. Hedging is accomplished by incremental long or short investments in ETFs, future contracts or forward contracts associated with one or more of these broad market indexes. In addition, other variables can be used to trigger the hedging (total or partial) of all or some of the exposures, including variables such as (i) the difference between short and long term volatility, and (ii) the maximum sensitivity to price changes in any one asset class or broad market.

This is repeated for each of the beta components to provide a composite beta hedge or supplement for that portfolio. On a periodic basis, typically end-of-day or end-of-month, the individual beta components are processed and the investment overlay is modified to correct/re-target the volatility or betas for the portfolio, bringing them back in line to the target volatility level.

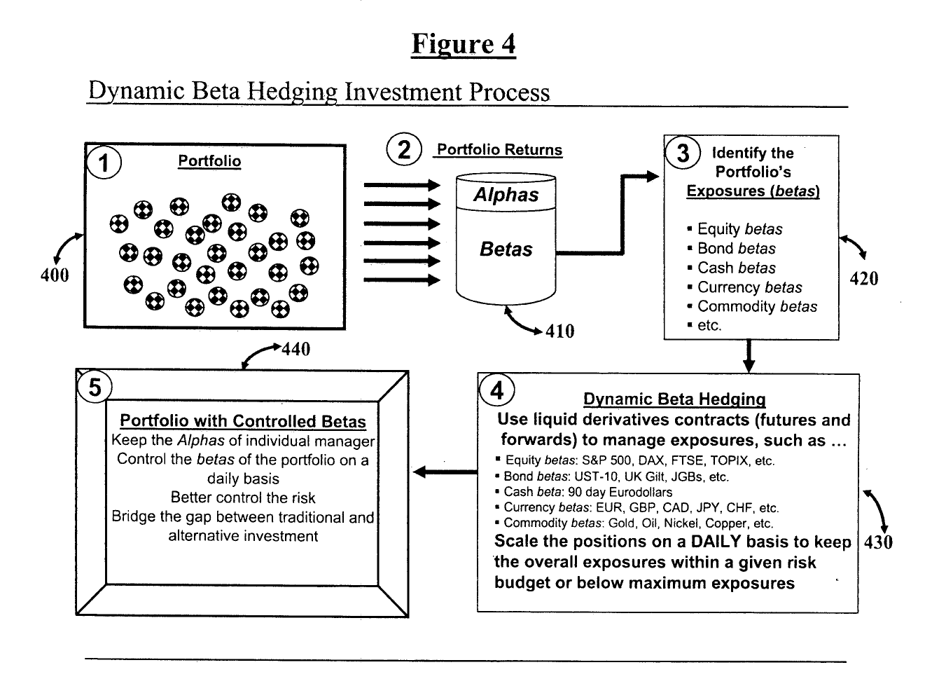

Operation of the computer system in accordance with these programming steps is provided graphically, beginning at FIG. 4. Block 400 depicts a portfolio of assets. While represented as common icons, a representative portfolio may be a heterogeneous mix of different assets and asset types. At process 410, the system provides projected alphas and betas for the portfolio. The individual beta components are segregated for each of the selected broad markets, block 420, and stored for that processing cycle.

On a date pre-selected for periodic adjustment, the system recalls the portfolio's beta for each broad market, and calculates an investment overlay that will modify the portfolio's betas in order to achieve a portfolio volatility at the target value, block 430. As discussed in more detail below, this process is repeated on a periodic basis so that the RP betas are proportionately scaled to achieve the target volatility or individually scaled to achieve the target betas. By adjusting the overlay daily, the portfolio is maintained within its target risk parameters on a daily basis even for an RP with only monthly price data available, Block 440.

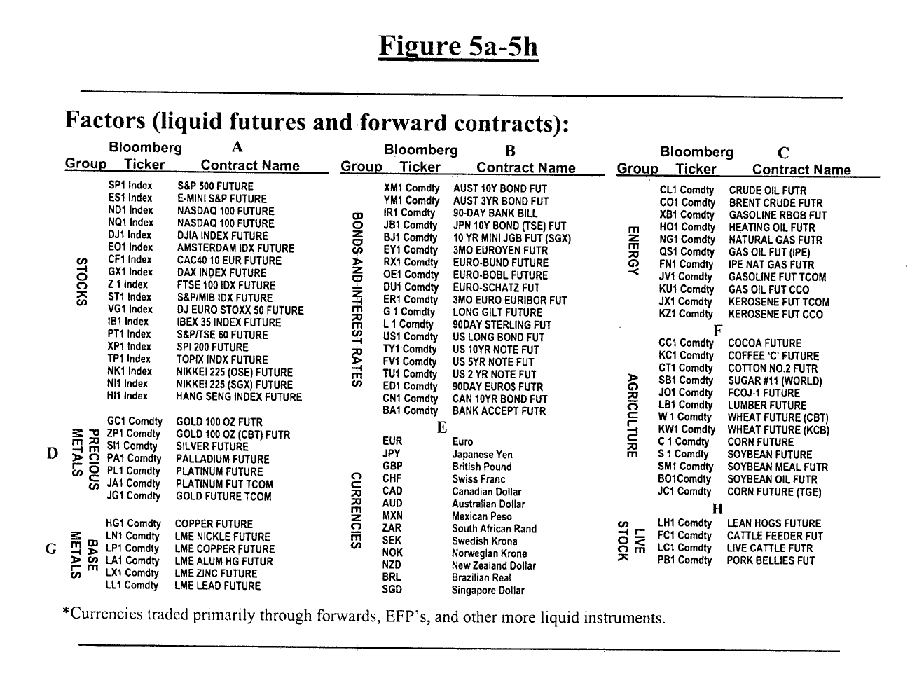

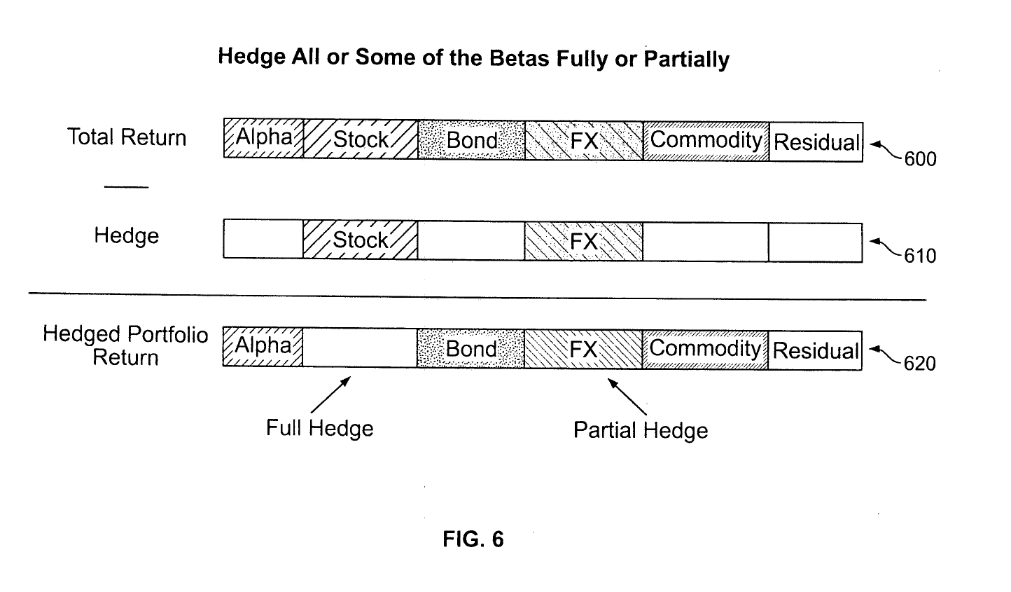

At each periodic interval (or in real time), the system automatically calculates the investment overlay for each beta to dynamically rebalance the portfolio. This involves increasing or decreasing the fund's position in select future or forward contracts (“factors”) associated with each broad market in order to modulate the portfolio's betas relative to those markets. These broad markets are delineated and illustrated in FIG. 5, with 5a reflecting illustrative equity factors, 5b delineating illustrative bond/interest rate factors, and 5c delineating illustrative commodity factors (here “energy”). Continuing in FIG. 5, precious metals are shown in 5d, currencies in 5e, agricultural products in 5f, base metals in 5g and finally livestock in 5h. Both futures and forwards may be used. Every day the overlay will dynamically adjust the exposure to each factor with the goal of keeping the overall volatility of the portfolio at or below a certain threshold (e.g., 4 percent). The overlay of factors (i.e., futures and forwards) is designed to proportionately offset any exposure of the portfolio to broad markets that would cause its estimated volatility to be in excess of the portfolio's target volatility on an ongoing basis (each month). Operation of the inventive system is fully customized. Betas may be fully or partially hedged (relative to the target volatility which can mean augmented as well as offset), depending on the objectives of the portfolio manager. In FIG. 6, bar charts compare the return from the portfolio sliced into its component betas—here stock, bond, currency (FX) and commodity—600. Continuing in FIG. 6, the investment overlay has two hedge positions as depicted in 610. The first is an equity hedge (stock) and involves a futures contract on the S&P 500—the quantity is full, meaning that the position is adjusted to fully offset the impact of the portfolio's equity exposure on its returns (reducing its expected equity beta to zero). The second is a currency hedge and it is partial, with the net currency exposure reflected by the hedged portfolio depicted in bar 620.

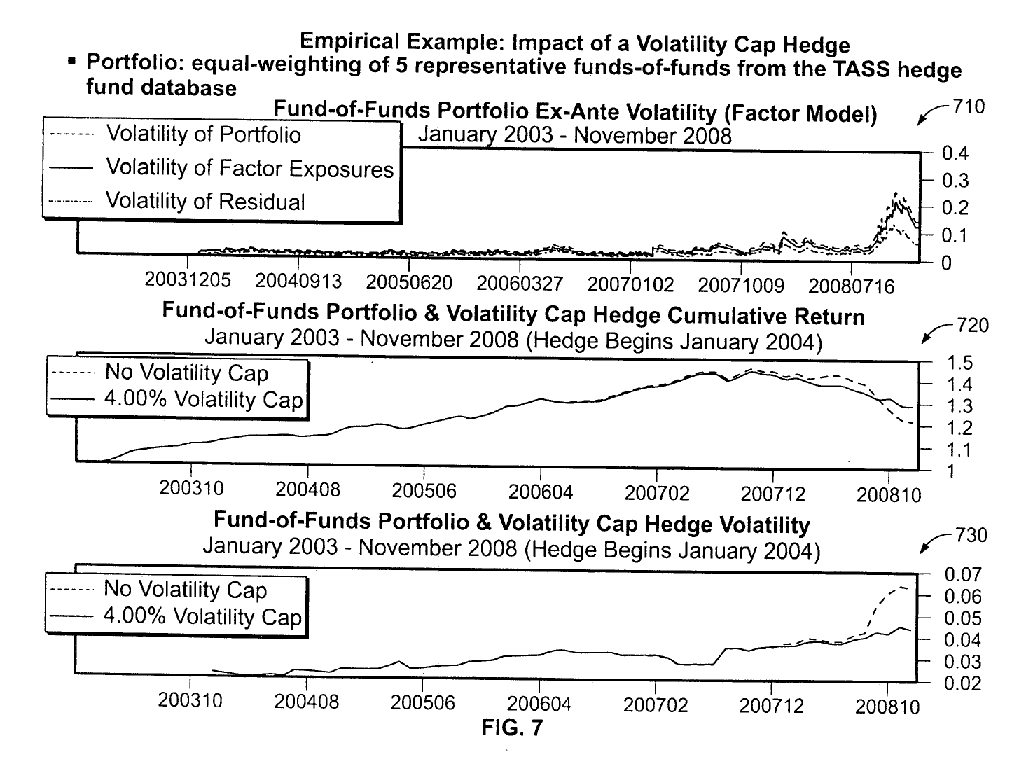

The foregoing principles of the present invention are illustrated in the next series of figures. In these, system operation is applied against a portfolio, using historical pricing to demonstrate hedge operation. In FIG. 7, three time charts are provided, each tracking select parameters for the five year window 2003-2008. In this series, the use of a volatility cap is demonstrated to control portfolio volatility (as measured by either the standard deviation of returns or its square, the variance of returns) over time. The first chart, 710, contrasts the volatility of the portfolio (5 representative fund of funds from the TASS hedge fund database) attributed to the broad markets as captured by the factors (e.g., a futures contract on the S&P 500) and the residual (alpha).

The second chart, 720 depicts both the portfolio's cumulative return hedged with the 4 percent cap and unhedged. During the bear market of 2008, the cap boosted performance of the portfolio above that otherwise achieved without the volatility cap. Prior to the highly volatile markets of 2008, the volatility-capped portfolio's performance largely paralleled that of the unhedged portfolio. The role of the 4 percent volatility cap is demonstrated by graph 730 where the volatility of the portfolio (capped and uncapped) is presented over time. Again, the role of the cap is amply evident from Table III below during the bear market of 2008.

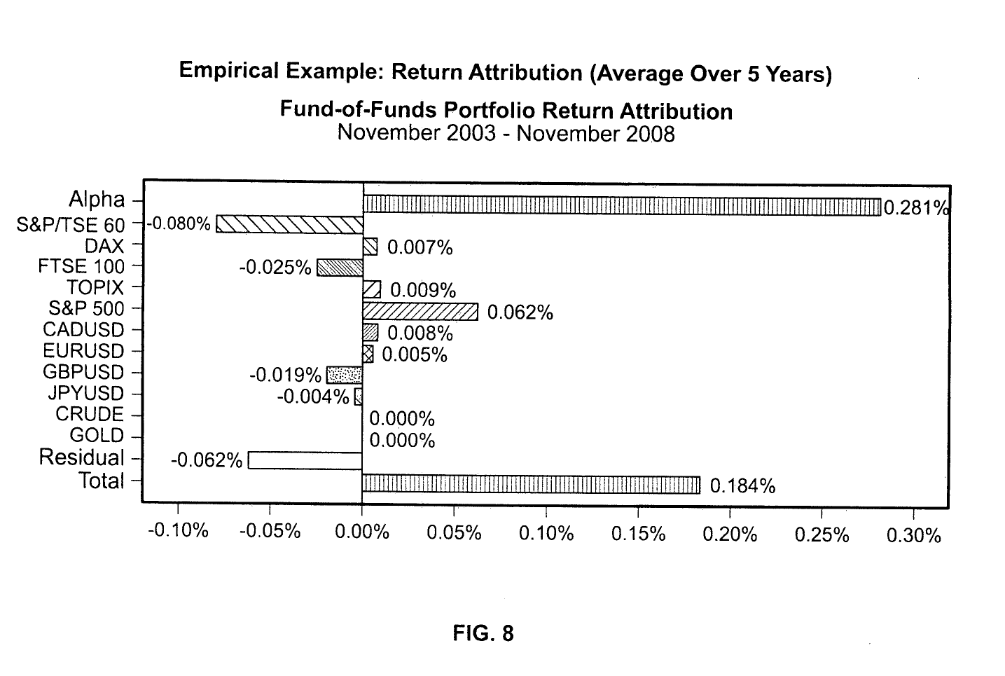

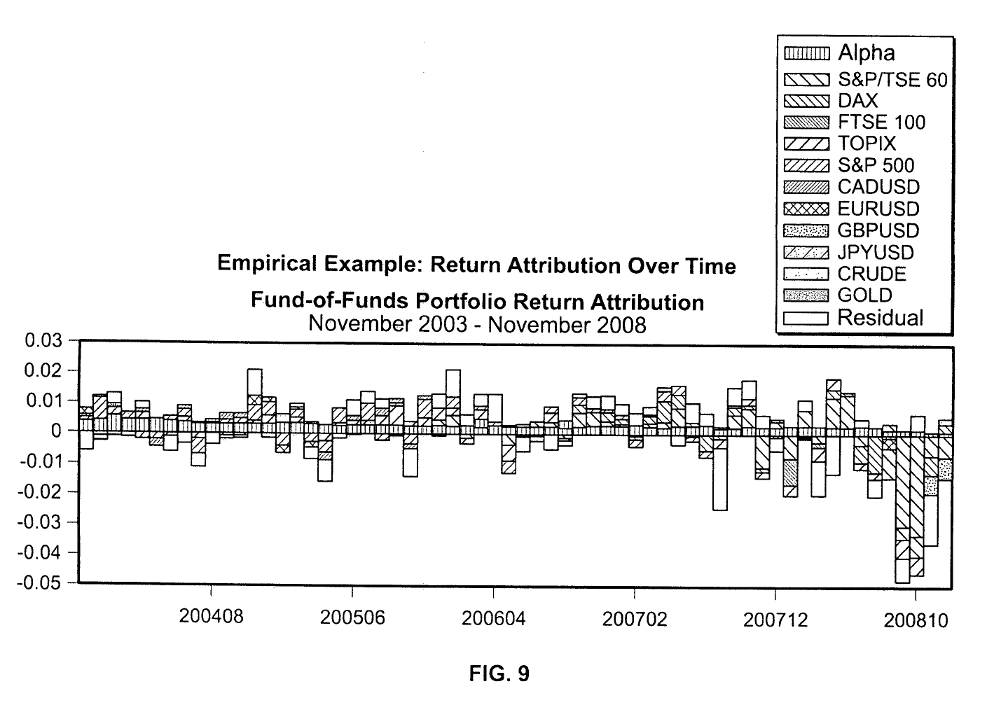

In the next two figures, the fund of funds' return attributes are broken down by factor (i.e., broad market exposures as captured by specific futures contracts) for the past five years. Specifically, in FIG. 8, the fund of funds for the five year period demonstrates an alpha of 0.281% or 28.1 basis points (bp) per month. The data depicts that most of the portfolio's losses are attributable to its equity market exposures, including an 8.0 by per month loss from the S&P/TSE 60 (Canada equity). In FIG. 9, the return/loss for the fund of funds over the select 5 year window depicts betas with respect to a variety of different factors; however, during 2008, equity betas were the most pronounced in triggering portfolio volatility and losses.

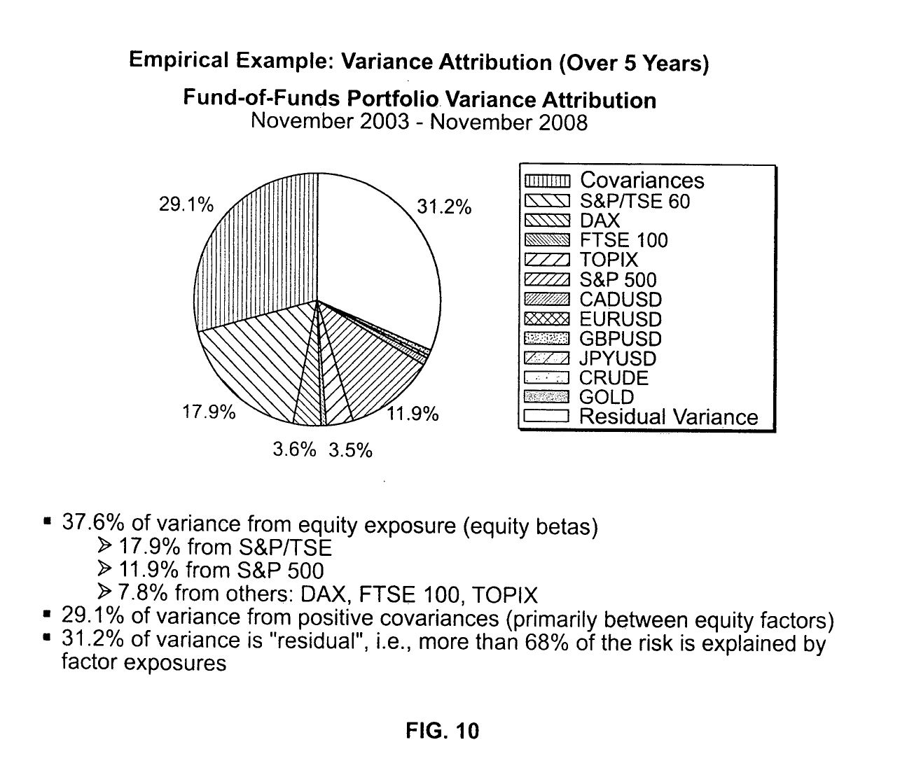

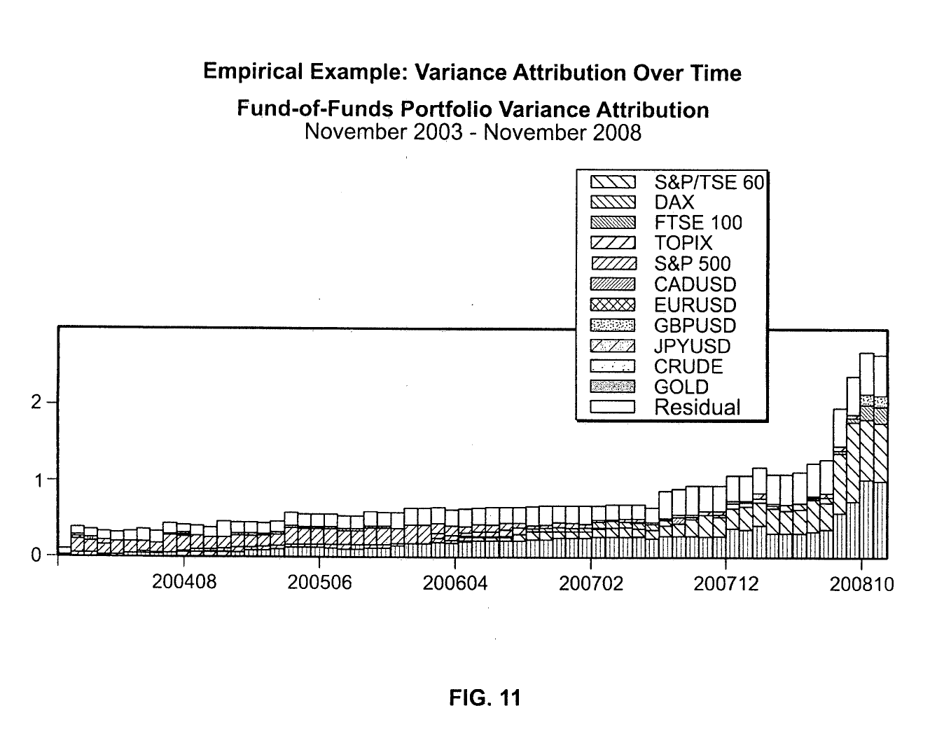

FIG. 10 provides the portfolio variance (i.e., volatility) attributed to each of the factors. Sixty-eight percent of total volatility is explained by broad market exposures (i.e., betas). Thirty-two percent remains as “residual.” For this five year interval, the portion of volatility attributable to equity factors is the most significant (almost 67 percent of total volatility is explained either by equity betas or the positive co-variances among them). For selected periods within the five year window, the volatility attribution changes—with the recent increase in volatility attributed to the portfolio betas. See FIG. 11.

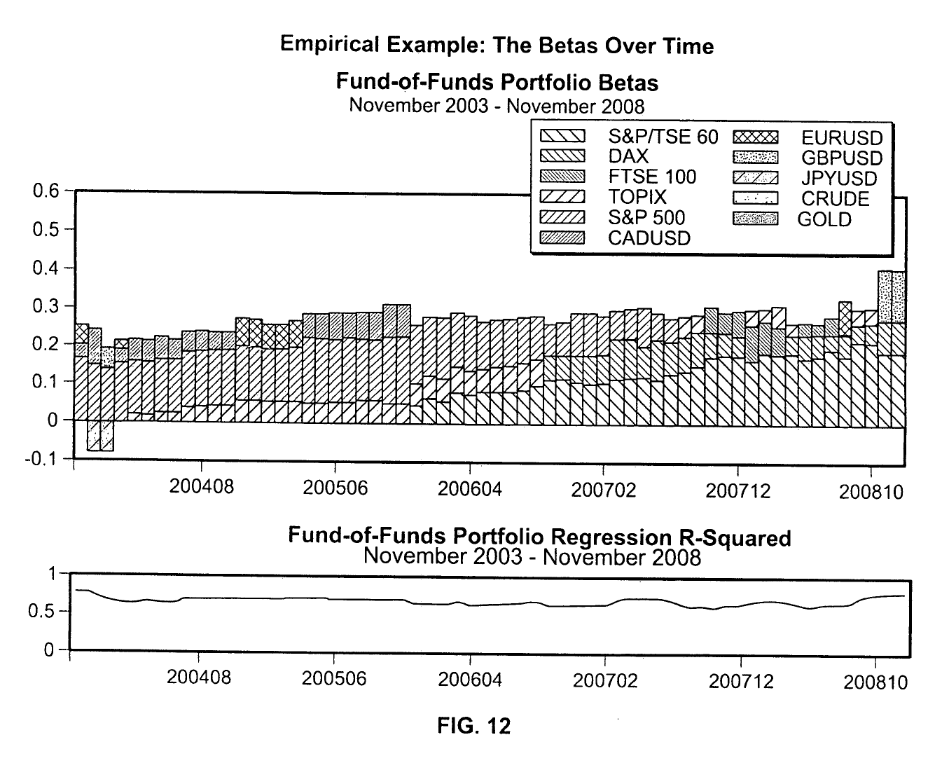

Finally, in FIG. 12, the interval studied demonstrates that even though the betas are not stable and change over time, the statistical significance of the broad market exposures as captured by futures contracts has been good in explaining overall portfolio volatility—consistently showing R-squared values above 0.6 during the entire interval. As shown in the Table below, use of the 4 percent volatility cap substantially reduced volatility of the portfolio without a significant performance penalty.

TABLE III

| | 2004 | 2005 | 2006 | 2007 | 2008 |
|---|---|---|---|---|---|
| | Portfolio | | | | |
| Annual Return | 6.7% | 6.1% | 8.8% | 6.6% | −16.0% |
| Annual SD | 2.5% | 3.3% | 3.1% | 4.0% | 6.4% |
| | Portfolio + 4% Volatility Cap | | | | |
| Annual Return | 6.7% | 6.1% | 8.6% | 5.5% | −10.0% |
| Annual SD | 2.5% | 3.3% | 3.1% | 4.0% | 3.5% |
| Impact on Performance | 0.0% | 0.0% | −0.2% | −1.0% | 6.0% |
| of the Overlay | | | | | |

The foregoing principles are given context in the following simplified illustration of a single beta portfolio that is risk-modified. For this illustration, a portfolio consisting of the Russell 3000 index stocks is tracked and adjusted to an annualized volatility target of 20%. In this case, market equity exposure (as measured by the sensitivity to the S&P 500) ranges from 96.9% to 97.5%, and the estimated S&P 500 volatility ranges from 31.1%-48.8%. These parameters imply that the portfolio volatility due to the S&P 500 factor ranges from 30.1% to 47.5%. This, in turn, results in excess S&P 500 volatility of 10.1%-27.5% implying a system-calculated portfolio weight for the S&P 500 futures overlay that ranges between −33.6% and −57.9%. This translates into selling futures contracts on the S&P 500 in an amount such that their notional value as a percentage of total portfolio capital is between 33.6% and 57.9%.

The above arrangement is described in Table IV below demonstrating the overlay used to maintain the portfolio volatility at or below the 20% target.

TABLE IV
Example: Managing the Risk of the Russell 3000 to a Target
Volatility of 20% using S&P 500 Futures on a Daily Basis

| | | | Estimated Vol | Excess | S&P Overlay |
|---|---|---|---|---|---|
| | Beta (S&P | Estimated | of S&P | Volatility | Position to |
| Date | Exposure) | S&P Vol | Exposure | (Over 20%) | Achieve 20% Vol |
| Mar. 9, 2009 | 96.9% | 31.1% | 30.1% | 10.1% | −33.6% |
| Mar. 10, 2009 | 97.2% | 39.6% | 38.5% | 18.5% | −48.0% |
| Mar. 11, 2009 | 97.1% | 37.7% | 36.6% | 16.6% | −45.4% |
| Mar. 12, 2009 | 97.2% | 41.3% | 40.1% | 20.1% | −50.1% |
| Mar. 13, 2009 | 97.2% | 41.4% | 40.2% | 20.2% | −50.3% |
| Mar. 16, 2009 | 97.2% | 41.1% | 39.9% | 19.9% | −49.9% |
| Mar. 17, 2009 | 97.2% | 42.3% | 41.2% | 21.2% | −51.4% |
| Mar. 18, 2009 | 97.3% | 41.8% | 40.6% | 20.6% | −50.8% |
| Mar. 19, 2009 | 97.2% | 42.0% | 40.9% | 20.9% | −51.1% |
| Mar. 20, 2009 | 97.2% | 42.7% | 41.5% | 21.5% | −51.8% |
| Mar. 23, 2009 | 97.4% | 48.8% | 47.5% | 27.5% | −57.9% |
| Mar. 24, 2009 | 97.4% | 47.7% | 46.4% | 26.4% | −56.9% |
| Mar. 25, 2009 | 97.4% | 46.6% | 45.4% | 25.4% | −56.0% |
| Mar. 26, 2009 | 97.5% | 46.9% | 45.7% | 25.7% | −56.2% |
| Mar. 27, 2009 | 97.5% | 46.9% | 45.8% | 25.8% | −56.3% |

100651 While the invention has been particularly shown and described with reference to a preferred embodiment, it will be understood by those skilled in the art that various changes in form and detail may be made therein without departing from the spirit and scope of the invention.

What is claimed is:

1. A computer system for dynamically hedging a portfolio by incremental investments in one or more beta-based hedging investments, said system comprising: a first computer interconnected to market data input for collecting information regarding an investment portfolio; a second computer for performing investment calculations, including collecting information regarding a plurality of target betas associated with the target volatilities or correlations for said investment portfolio and calculating a plurality of investments in future or forward contracts that adjust the individual betas associated with said investment portfolio to approximate said target betas of said portfolio; and an investment report generation processor associated with said second computer for determining an investment overlay comprising said plural investments that, coupled to said investment portfolio, correspond to a target volatility without substantially altering the non-cash asset allocation of the investment portfolio; wherein said first and second computers may be the same selectively programmed computer.

2. The system of claim 1 wherein said target betas include an equity beta, currency beta, fixed income beta, short-term interest rate beta and a commodity beta.

3. The system of claim 2 wherein said commodity betas includes one or more of livestock, precious metals, base metals, energy and grains.

4. The system of claim 1 wherein said investment overlay is a position in one or more future contracts, forward contracts or ETFs, and the position is incrementally assessed on a periodic basis.

5. A computer based method for reducing or increasing the betas of a portfolio comprising the steps of: inputting and/or storing data in a computer defining a first portfolio where said portfolio comprises a series of investments; determining with said computer multiple betas for the portfolio; inputting and/or storing into said computer a target volatility for the portfolio; calculating with said computer an overlay investment; tracking and/or storing market data associated with said portfolio; calculating with said computer changes to said overlay investment so as to dynamically adjust one or more betas of said portfolio so as to approximate the target volatility for the portfolio without impact on the portfolio's relative allocation among broad market exposures (other than cash).

6. The method of claim 5 wherein said portfolio betas are comprised of individual betas corresponding to different investment sensitivities.

7. The method of claim 6 wherein the individual betas include equity betas, currency betas, and a short term interest rate beta.

8. The method of claim 7 wherein said individual betas further comprise a commodity beta.

9. The method of claim 5 wherein said dynamic adjustment step further comprises the step of purchasing and/or selling ETFs, OTC forwards or future contracts on one or more exchanges.

10. The method of claim 9 wherein said ETFs, futures contracts and forward contracts are based on the S&P 500 Index, the Dow Jones Index Average (DJIA), the Russell 1000, the Russell 3000, the DAX, FTSE and/or TOPIX.

11. The method of claim 5 wherein the investment overlay includes the purchase or sale of a futures or forward contract in a select asset class.

12. The method of claim 11 wherein the dynamic adjustment of the portfolio involves a computer test comparing the expected volatility to target volatility and recalculating the overlay investment in response to the comparison.

13. The method of claim 12 wherein the comparison step applies a volatility cap wherein the investment overlay is adjusted if said cap is exceeded by said expected volatility.

14. The computer method of claim 5 further includes the step in a computer of determining an estimated volatility for said first investment portfolio.

15. The computer method of claim 14 wherein the estimated volatility is based on a proxy portfolio.

16. The computer method of claim 15 wherein the proxy portfolio is comprised of broad market indexes.

17. A computer system comprising:
a first processor programmed to determine a volatility modifying investment that counter balances a referencing portfolio to create a volatility controlled portfolio, wherein the volatility modifying investment comprises at least one of: a position in one or more future contracts and a position in other assets,
a computer interface for receiving data relating to price trends for assets within said volatility controlled portfolio, and
a storage medium for storing market data and volatility parameters, wherein said storage medium stores said volatility modifying investment and a volatility target,
wherein said first processor is further programmed to calculate adjustments to said volatility modifying investment so as to substantially maintain an expected future volatility in accordance with said volatility target.

18. The system of claim 17 further comprising a network communication framework permitting access to said data on said storage media by workstations remotely located from said storage medium.

19. The system of claim 17 wherein said computer system further comprises a data server linked to said storage medium to permit access to market data by said first processor and the storage of interim and final volatility parameters.

20. The system of claim 17 further comprising a second processor for tracking historical pricing data for select securities and calculating an expected volatility for a portfolio comprised in part of said selected securities.

21. The system of claim 20 wherein the first and second processors are physically the same processor.
